(19) United States
(12) Patent Application Publication
(10) Pub. No.: US 2006/0243472 A1
(43) Pub. Date: Nov. 2, 2006

(54) [MAINFRAME MOUNTING STRUCTURE]

(75) Inventors: Kang Ku, TAIPEI (TW); Hsien-Tang Liu, TAIPEI (TW); Chia-Yen Hsu, TAIPEI (TW)

Correspondence Address: DATAVAN INTERNATIONAL CORP., P.O. BOX 108-00403, TAIPEI, TW

(73) Assignee: DATAVAN INTERNATIONAL CORP., Jhonghe City, Taipei Hsien. (TW)

(21) Appl. No.: 10/908,151

(22) Filed: Apr. 28, 2005

(51) Int. Cl. H02G 3/08

(52) U.S. Cl. 174/50

(57) ABSTRACT

A mainframe mounting structure is disclosed to include a mainframe body, which has a base frame defining an accommodating chamber, two side panels at two opposite lateral sides of the base frame, a sliding groove at each side panel, and connector modules mounted in the base frame, and a circuit module, which includes a sliding carrier detachably slidably inserted into the sliding grooves at the side panels of the mainframe body and a circuit board carried on the sliding carrier and having connectors connectable to respective connecting portions of the connector modules inside the mainframe body.

### BACKGROUND OF THE INVENTION

1. Field of the Invention

The present invention relates computers and more particularly, to a mainframe mounting structure, which allows quick replacement of the circuit module without damaging the circuit board.

2. Description of the Related Art

Industrial PCs (personal computers) are developed to satisfy industrial requirements for high-speed machines and open architecture. An industrial PC is used to control automated machines, and the control is executed through a control module inside the mainframe. The mainframe of an industrial PC having the design for DIN-Rail mounting comprises a disk drive, a motherboard, a power supply unit, and other component parts. The motherboard has a microprocessor for controlling the operation of the computer, and a control circuit for controlling connection between the work machine and the main control unit. The circuit wiring of an industrial computer must be designed subject to the arrangement of the controlled work machines and main control unit. If the microprocessor control circuit and the circuit wiring are separately designed, the microprocessor control circuit and the circuit wiring must be redesigned when new wok machines and main control unit are used. According to conventional designed, it is complicated to change the arrangement of the microprocessor control circuit and the circuit wiring to fit a different work machine and main control unit. In order to eliminate this problem, a mobile controller is developed. According to this design, the mobile controller comprises a circuit board slidably insertable into the casing of the industrial PC. This design allows quick replacement of the mobile controller. However, because the circuit board of the mobile controller is a thin member having a thickness about 2 mm, it tends to be damaged during installation. If the applied force to push the circuit board into the casing is not evenly applied to the circuit board, the circuit board may break. Further, because the mainframe of the industrial PC has no support means to support the circuit board, the circuit board may be forced to curve by the heavy weight of the component parts carried thereon.

Therefore, it is desirable to provide a mainframe mounting structure that eliminates the aforesaid problems.

### SUMMARY OF THE INVENTION

The present invention has been accomplished under the circumstances in view. According to the present invention, the mainframe mounting structure comprises a mainframe body, and a circuit module mounted inside the mainframe. The mainframe body comprises two sliding grooves arranged in parallel at two side panels at two sides of the base frame thereof. The circuit module comprises a sliding carrier, which has two sliding rails insertable into the sliding grooves at the side panels of the mainframe, and a circuit board carried on the sliding carrier. Because the circuit board is carried on the sliding carrier, mounting/dismounting the circuit module does not damage the circuit board accidentally.

### BRIEF DESCRIPTION OF THE DRAWINGS

FIG. 1 is an elevational view of a mainframe mounting structure according to the present invention.

FIG. 2 is an exploded view of the mainframe mounting structure according to the present invention.

FIG. 3 is an exploded side view of the mainframe mounting structure according to the present invention.

FIG. 4 corresponds to FIG. 3, showing the top cover fastened to the base frame.

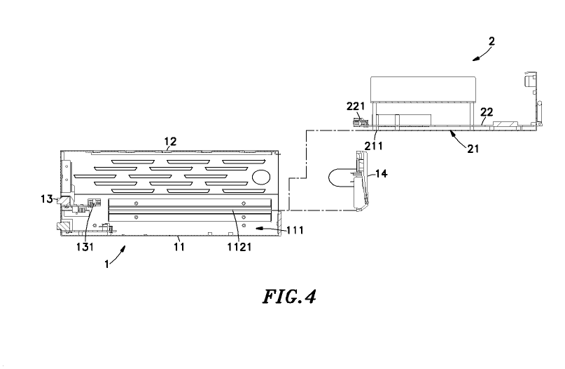

FIG. 5 is a sectional side view showing the mainframe mounting structure assembled according to the present invention.

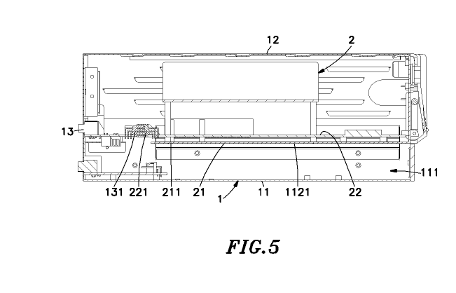

### DETAILED DESCRIPTION OF THE PREFERRED EMBODIMENT

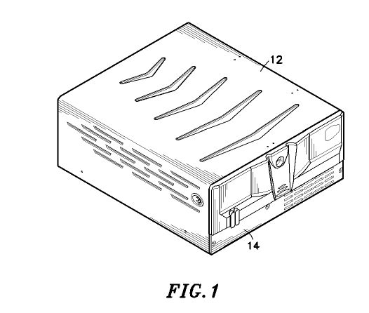

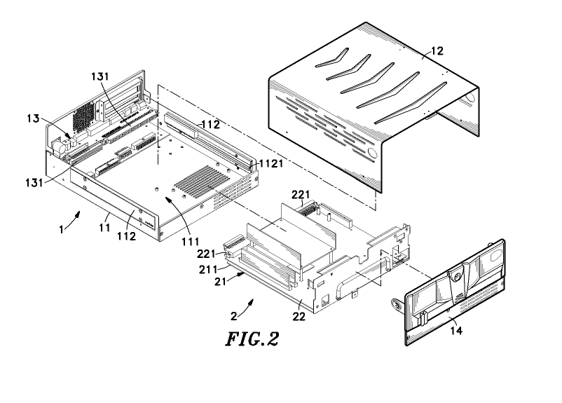

Referring to FIGS. 1 and 2, a mainframe mounting structure in accordance with the present invention is shown comprised of a mainframe body 1 and a circuit module 2.

The mainframe body 1 is comprised of a base frame 11, a top cover 12, connector modules 13, and a side cover 14. The base frame 11 defines therein an accommodating chamber 111, having two side panels 112 arranged in parallel at two opposite lateral sides. The side panels 112 are respectively extruded from aluminum, each having a sliding groove 1121 extending along the length. The top cover 12 covers the base frame 11 over the accommodating chamber 111. The connector modules 13 are mounted in the base frame 11 near one side, each having a connecting portion 131 positioned in the accommodating chamber 111. The side cover 14 is covered on one side of the base frame 11 between the two side panels 112 remote from the connector modules 13.

The circuit module 2 comprises a sliding carrier 21, which has two sliding rails 211 symmetrically disposed at two opposite lateral sides thereof and respectively insertable into the sliding grooves 1121 at the side panels 112, and a circuit board 22 detachably mounted on the sliding carrier 21. The circuit board 22 comprises a plurality of connectors 221 respectively electrically connectable to the connecting portions 131 of the connector modules 13.

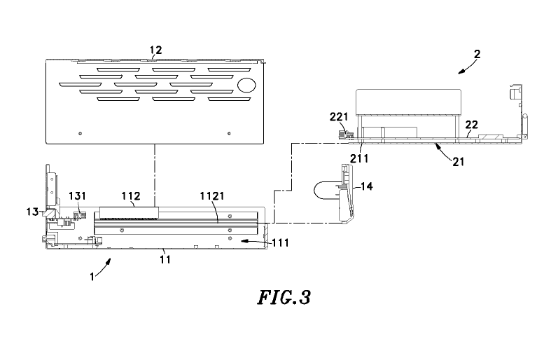

Referring to FIGS. 3˜5, during assembly process, the side cover 14 is detached from the base frame 11, and then the circuit module 2 is inserted into the sliding grooves 1121 at the side panels 112 of the base frame 11 to force the connectors 221 into connection with the connecting portions 131 of the connector modules 13 respectively, and then the side cover 14 is fastened to the base frame 11 again. Because the circuit board 22 is carried on the sliding carrier 21, mounting or dismounting the circuit module 2 does not cause damage to the circuit board 22 accidentally.

Further, when wishing to replace the circuit board 22, the replacement work can conveniently be performed when opened the side cover 14 and pulled the sliding carrier 21 out of the base frame 11.

As indicated above, the invention is characterized in that by means of inserting the sliding rails 211 of the sliding carrier 21 of the circuit module 2 into the sliding grooves 121 at the side panels 112 of the base frame 11, the circuit module 2 can smoothly be moved in and out of the mainframe 1, and mounting/dismounting the circuit module 2 does not cause damage to the circuit board 22 accidentally.

Although a particular embodiment of the invention has been described in detail for purposes of illustration, various modifications and enhancements may be made without departing from the spirit and scope of the invention.

1. A mainframe mounting structure comprising:
a mainframe body, said mainframe body comprising a base frame, an accommodating chamber defined in said base frame, two side panels at two opposite lateral sides of said accommodating chamber, and two sliding grooves respectively formed at said side panels and facing said accommodating chamber; and
a circuit module detachably mounted in said mainframe, said circuit module comprising a sliding carrier insertable into said accommodating chamber, said sliding carrier comprising two sliding rails symmetrically disposed at two opposite lateral sides thereof and respectively insertable into the sliding grooves at said side panels of said mainframe, and a circuit board detachably mounted on said sliding carrier.

2. The mainframe mounting structure as claimed in claim 1, wherein said mainframe body further comprises a top cover covered on said base frame over said accommodating chamber.

3. The mainframe mounting structure as claimed in claim 1, wherein said mainframe body further comprises a side cover fastened to said base frame at one side.

4. The mainframe mounting structure as claimed in claim 1, wherein said mainframe body further comprises at least one connector module for the connection of said circuit board of said circuit module electrically.

5. The mainframe mounting structure as claimed in claim 4, wherein said at least one connector module has a connecting portion.

6. The mainframe mounting structure as claimed in claim 5, wherein said circuit board of said circuit module comprises at least one connector for for connecting to the connecting portion of each of said at least one connector module.

7. The mainframe mounting structure as claimed in claim 1, wherein said side panels of said mainframe are extruded from aluminum.
